(19) United States
(12) Patent Application Publication
(10) Pub. No.: US 2003/0048862 A1
(43) Pub. Date: Mar. 13, 2003

(54) Automatic calibration & synchronization for digital asynchronous communication

(76) Inventor: Hsin-Hsien Lee, Taipei City (TW)

Correspondence Address: Hsin-Hsien Lee, PO Box 82-144, Taipei, TW

(21) Appl. No.: 09/948,565

(22) Filed: Sep. 10, 2001

(51) Int. Cl. H04L 25/38

(52) U.S. Cl. 375/370

(57) ABSTRACT

Methods for automatically calibration & synchronization for digital asynchronous communication., the inverter comprising: (a) initialing a target device; (b) beginning to counting as soon as the target device is detected by a falling edge of a incoming START bit; (c) ending up the counting until a rising edge of the START bit detected; (d) storing a counting result; (e) setting the result/2 to be a sampling pointer; (f) compensating a latency and elapsing a first wait loop; (g) sampling and storing a first bit; (h)compensating a latency and elapsing a second wait loop; (i) sampling and storing in accordance with bits; (j) identifiing to sampling and storing 8 bits; (k) locating a Inter Character Region according to the initialing; finally, repeating to step(b)˜step(k).

### BACKGROUND OF THE INVENTION

1. Field of Invention

This present invention relates in general to digital communication by using asynchronous mode such as used in data acquisition systems, remote reporting and controlling systems, data terminals, micro-processor based sub-communication systems, hardware monitoring systems or just about any asynchronous system without built-in UART (Universal Asynchronous Receiver and Transmitter) mechanism.

2. Related Art

Among various digital communication, using asynchronous may benefit many advantages and one of these is, asynchronous communication have the characteristics of better data throughput because it requires no acknowledge overhead each time when communicate to each other and eliminate hardware handshake signals used in synchronous communication. However, to maintain a successful asynchronous communication, “initiator” and “target” device must maintain a precise time slice in order to clocking data correctly. This precise time slice require a precise time-base generator and/or a frequency locking circuitry.

In a asynchronous network, any device can initiate the communication task as long as the bus is free for accessing. To simplify the elaboration, we use “point-to-point” configuration as example, and use IEEE-232 as the communication protocol.

Refer to FIG. 1, Basic “point-to-point” asynchronous communication, As the FIG. 1 illustrated, “point-to-point” asynchronous communication

Refer to FIG. 2, IEEE-232 typical byte-frame profile_a typical asynchronous signal transmitted over the wire in between two devices may looks like this, and, in order to extract correct data out of stream, generally the receiver utilize a 16-X frequency to sampling the incoming stream pulses and then use voting algorithm to elects what has been grabbed. Shall the sampling frequency drifted due to whatever reasons, it is possible that the incoming stream could be out of lock and then communication become disconnected. The 16-X frequency is a frequency 16-time faster than the signal to be sampled. For grabbing 9600 baud data, the sampling frequency need to be (9600×16=153.6 KHz).

Other than maintaining a costly precise time-base and/or a frequency locking mechanism in both “initiator” and “target” devices. In addition, because of asynchronous communication characteristic, both devices are required to operate at the same speed—the baud rate setting need to be the same. In many cases, the baud rate selection is done by hardware setting like using a DIP (Dual In-line Package)switch. Sometimes the hardware baud rate setting is just infeasible. Reasons for these infeasible or difficulties, could due to “initiator” and “target” are geographically separated, lack of technical personnel to configure the hardware baud rate setting and may just physically inaccessible to the hardware baud rate setting.

This present invention demonstrate alternatives other than the baud rate setting, and the algorithm of this present invention may eliminating the necessity of precise time-base and/or frequency locking mechanism.

Refer to FIG. 3, “Strobe serial data at the proper timing”, the only prerequisites of this present invention is the “initiator” device shall remains the precise time-base and/or frequency locking capability. A selected code send by initiator” is character U for this present invention. The reason of selecting character U is basically because the binary code of U is 01010101 which has the best DC balance characteristic over the transmission line. While if a U being transmitted at 9600 baud, each bit-frame time width is equivalent to (1/9600=104 us) approximately. Similarly, if the character U being send at 4800 baud, the bit-frame time width is (1/4800=208 us) accordingly.

As soon as the “initiator” sending a character U, the “target” is simultaneously being notified by the the falling edge of the START bit. This phenomena is generally called “interrupt”. The response time in between the “target interrupted” to the following interrupt process routine(s) should be minimized, else, consequence a certain level of error occurs probability.

As mentioned earlier, while any data being transmitted at 9600 baud, each bit-frame time width is 104 us, to properly sampling each incoming bit stream, other than using the 16-X frequency, instead, a single sampling pulse (may named strobe) maybe used for minimized the “target” device utilization and may therefore reduce EMI (Electro Magnetic Interference). For best stable sampling, the sampling strobe need to be take place at exactly the center of each bit-frame which is 104/2=52 us. In practical, the sampling strobe may not existed, it is to indicate when will be the best timing for retrieving data.

The 52 us sampling interval is easily achieved if the “target” device has a precise time-base or frequency mechanism. However, for a non-precise time-base “target” device, this 52 us sampling strobe maybe hard to obtain. This present algorithm should be implemented in order to have similar result when using a such non-precise time-base “target” device.

For the equal quality result, the non-precise “target” device acts as:

1. as soon as the “target” is interrupted, the “target” device start to counting. . .

2. the “target” device keep on counting until the START bit has been elapsed or the first data bit is reached.

3. Once the first data bit has been reached, store the counting result at any pre-defined location. Whatever the the counter result is, the result is mapping to 104 us (for 9600 baud). Once the receiving device counter result has been determined, the time constant of (result/2) is used for locating the sampling strobe at the center of each following bits. Once the “target” device has the reference to locating the center of each bit-frame, the rest data over the incoming stream can be retrieved correctly.

Base on the procedures described in previous sections, this algorithm is basically performing a self-calibration task base on the first bit of the signal send from a remote device. Once the calibration is done, the result is the offset parameter for clocking the rest incoming bits, and, since the “target” device has the reference and knowing when to sampling the following data, there is no margin for errors.

### SUMMARY OF THE INVENTION

In many asynchronous communication systems, there are numbers of terms have been used for describing the relationship in between nodes. These terms are non-standard, however, these terms are getting popular and widely known by users. For example, following terms are frequently seen, “master & slave”, “initiator & target”, “talker & listener”.

Whatever terms used, in asynchronous network, only two (2) devices are activated at a time, unless in broadcast mode—one talker and many listeners, for the rest devices in this broadcasting network, they are in stand-by mode until they were addressed. Hereinafter, in this present invention, we use “initiator & target” as the terms for elaborating the algorithm. In a asynchronous network, any device can initiate the communication task as long as the bus is free for accessing. To simplify the elaboration, we use “point-to-point” configuration as example, and use IEEE-232 as the communication protocol.

Refer to FIG. 1, Basic “point-to-point” asynchronous communication, As the FIG. 1 illustrated, point-to-point” asynchronous communication system consist two(2) nodes. Either one of these two nodes can initiate the communication. To initiate the communication, according to IEEE-232 standard stated, the “initiator” simply pull the Txd signal low to notify the other node the communication is started. The node which pull the Txd low is the “initiator” and the other node being notified is declared as “target” device.

The high-to-low transaction on the Txd line is a pre-defined “START” pattern condition listed in the IEEE-232 standard. Once the Txd being pull low, at the meanwhile, the other device is being notified that the pre-defined “START” bit (or condition) is taking place. As soon as the “target” device is notified and it should be ready for receiving the rest data send by “initiator”. These simple procedures is called “target synchronization” which means that the target device is synchronized to the initiator. Once the target device is synchronized to the initiator, the target device then use a pre-defined timing according to the pre-defined baud rate in between the “initiator” and the “target” devices to correct grabbing the following incoming data streams.

When the synchronization in between the “initiator” and the “target” devices has been established, data grabbing (or data clocking) task must rely on a stabled time-base mechanism to maintain a successful asynchronous communication. Any unstable time-base mechanism in either the “initiator” or the “target” device may cause the grabbing timing slipped out of the bit-frame. If such problem occurred, communication error occurs.

To maintain a successful asynchronous communication, based on previous mentioned requirements, a stable time-base and/or a frequency locking mechanism must be equipped in both “initiator” and the “target” device. Unfortunately, these precise time-base circuitry or frequency locking circuitry may consequence the cost increase. This present invention demonstrate the algorithm which eliminate the necessity of a stabled time-base and/or frequency locking mechanism for “target” device. This present invention may result the cost decrease while maintain the equal quality of any conventional asynchronous communication.

This present invention demonstrate the capability of eliminating the necessity of sophisticate time-base circuitry in the asynchronous “target” device and the quality of communication remains unchanged. The advantages of using this invention are cost reduction because of eliminating the sophisticate time-base circuitry, processor independent and automatic baud rated.

The elaboration of this invention is formed as: conceptual description, modeling construct and mathematical measuring and verify the algorithm. One of the major features of using this invention—accumulated timing drift cancellation, is also elaborated and proved by measuring the actual value.

### BRIEF DESCRIPTION OF THE DRAWINGS

The present invention will become more fully understood from the detailed description given hereinbelow illustration only, and thus are not limitative of the present invention, and wherein:

FIG. 1 Basic “point-to-point” asynchronous communication—to illustrate the minimum requirement of a typical asynchronous.

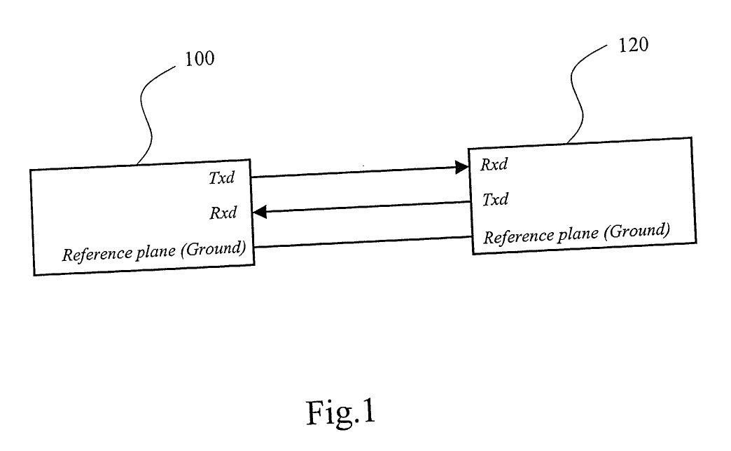

FIG. 2, IEEE-232 byte-frame profile—to illustrate a typical IEEE-232 byte frame structure.

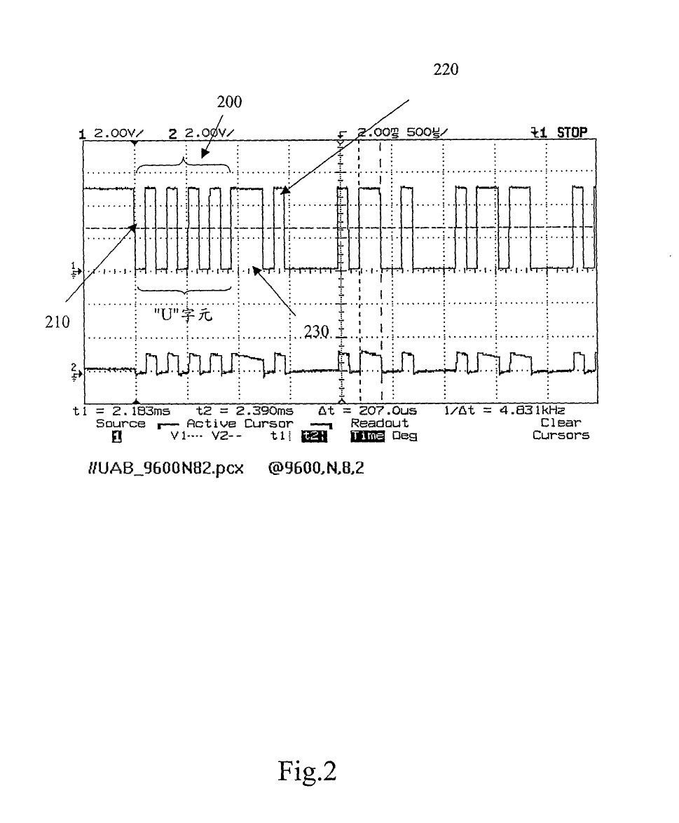

FIG. 3, “Strobe serial data at the proper timing”—to illustrate the criteria of sampling strobe signal and it's importance.

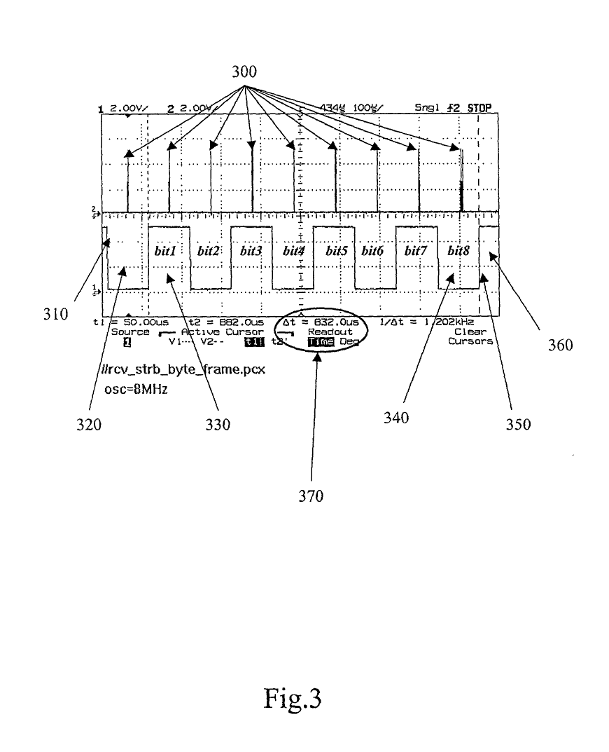

FIG. 4 “Algorithm flow-1”—The algorithm main flow chart 1.

FIG. 5 “Algorithm flow-2”—The algorithm main flow chart 2.

FIG. 6, “Possible timing drift caused by device response performance”—to illustrate the possible timing drift caused by target device performance.

FIG. 7, “Possible sampling timing drift”—to illustrate the possible timing drift caused by accumulated timing variation.

FIG. 8, “criteria of drifting margin & sampling ahead technique”—to illustrate the maximum allowable timing drift margin and correct by “sampling ahead” technique.

FIG. 9, “Accumulated latency/delay measured at 8 MHz”—to illustrate and quantumtize the latency/delay of using a processor runs at 8 MHz speed.

FIG. 10, “Calibrated sampling timing at the 1st bit-frame”—to illustrate the profile of a calibrated sampling strobe timed at the 1^{st} bit frame.

FIG. 11, “Accumulated latency/delay at 8th bit-frame”—to illustrate the profile of a calibrated sampling strobe timed at the 8^{st} bit frame.

FIG. 12, “Accumulated latency/delay cancellation”—to illustrate how the result of the accumulated latency/delay has been cancelled.

FIG. 13, “A BERT program”—to illustrate a Bit_Error_Rate_Test (BERT) program and the test result.

### DETAILED DESCRIPTION OF THE INVENTION

The detail of this present invention is categorized into two (2) major sections: first, construct modeling & description and, the second, verification mathematically.

Construct Modeling & description:

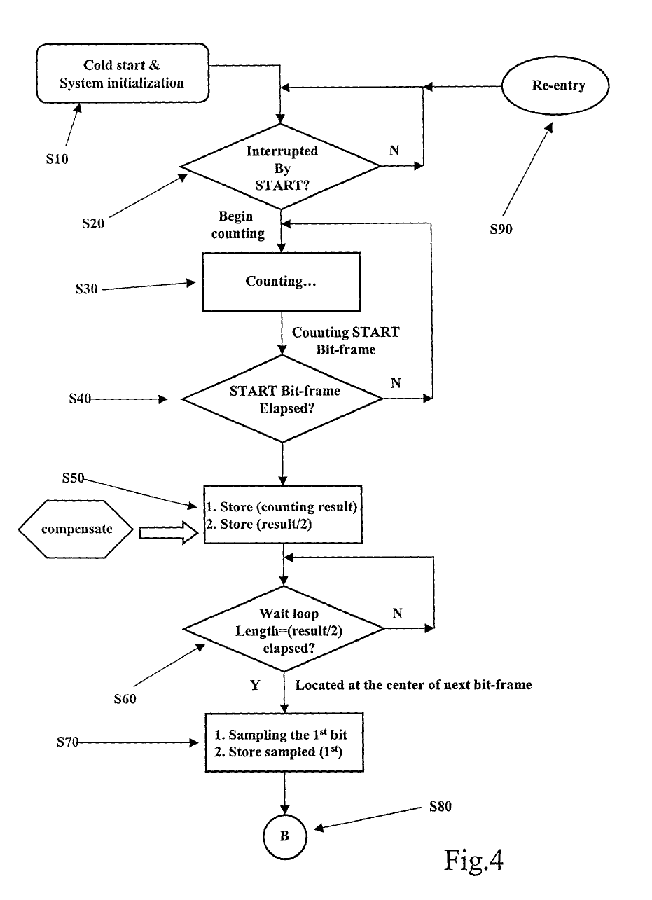

Refer to FIG. 4, at the step 10, this shall take place when the “target” device is right after the power has been applied or performed a hardware reset. A series of system initialization tasks will be performed. Once all these required tasks have completed, system is in step 20.

While in step 20, the “target” device is awaiting an interruption signal send from a remote device. As soon as the “target” device is interrupted by a falling edge of a incoming IEEE-232 START bit, “target” device begin to counting. The counting task remains (step 30) until the first rising edge signal detected (step 40). Also, once the 1^{st} rising edge signal ends up the counting, this also indicates that the START bit has been elapsed.

The first rising edge signal indicating the beginning of the 1^{st} data bit has been detected. The 1^{st} bit is also the LSB (Least Significant Bit) of IEEE-232 data. There are plenty of choices for the first character. For best transmission line DC balance, the character U (hex 55 h) is recommended since its binary pattern is 01010101, the signal level alternated ONEs and ZEROs the every other bits. The signal energy spectrum level is therefore also unified. This benefit the transmission line has least chance to get stuck at either levels and reduce errors. The 1^{st} character for “target” device is the calibration purpose, other than character U, there are many choices, such as, A, C, E, G. I . . . . , as long as the LSB is a logic ONE.

Once the START bit-frame counting has been completed, the counting results are stored to any appropriated locations. These includes the (result) and (result/2). This is at step 50. At this point, we must practice the possible error analysis, for a perfect time-based system, each bit-frame of a 9600 baud transmission, is equivalent to (1 sec/9600=104 uS), for a complete ASCII character which consist 8 data bits. 832 uS is the total time required for sending/receiving a such data.

For a non-precise time-base “target” device, the counting result may not be exactly the same as 104 us. For a faster time-base device, the result could be greater than 104 and a slower device could be less than 104. Whatever the result was, the result is the function of 104. Other than the mapping relationship with 104, every computation device like the “target” device here, always consume certain amount of time (function of number of instructions being executed) before getting the result (eg the “result and ”result/2”). This time latency must put in count against the 104. In other words, the counting result from step 30 and 40 must be offset or compensated.

After the counting result has been properly compensated and stored. The pointer is actually located at the boundary line of the START and the 1^{st} bit, issuing a (wait-loop=(result/2)) can locating the sampling pointer at the center of 1^{st} data bit-frame. This is at step 60

Once the pointer is located at the center of the 1^{st} data bit-frame, perform sampling data. If the first character being used is based on the concept elaborated in above mention, the 1^{st} bit must be a logic ONE. Store the sampled data to any appropriate location accordingly. This is done in step 70.

After the 1^{st} data bit has been sampled and stored. The pointer is actually located at slightly behind the center of the 1^{st} data bit-frame. At this time, perform another (wait-loop length=result) enabling the pointer locate at somewhere slightly behind the center line of the next data bit-frame. Do perform sampling data, store whatever sampled and repeats until all the rest 7 bits has been properly retrieved. These steps all done at step 10 step 110, and 120.

After all 8 bits of the first character has been retrieved and stored, pointer must locating the ICR delay region (Inter Character Region). The ICR is the guard band in between characters. The ICR can be one (1) bit-frame wide or one-and-half(1.5) or two (2) bit-frame wide. The function of locating ICR is done by step 130.

Once the ICR region is located, it is in “re-entry” state which is step 90. While in State9, it is return to almost the beginning of the process cycle. The difference in between the State9 and cold start are those cold start initialization process are not implemented when in re-entry state.

Further error analysis:

Similar to the analysis elaborated in the section step 50. While grabbing data and store routine for the rest 7 bits are also affected by certain level of timing issues. There are number of causes of the timing drift. Following describe those causes and measures.

EA1. Interrupt latency:

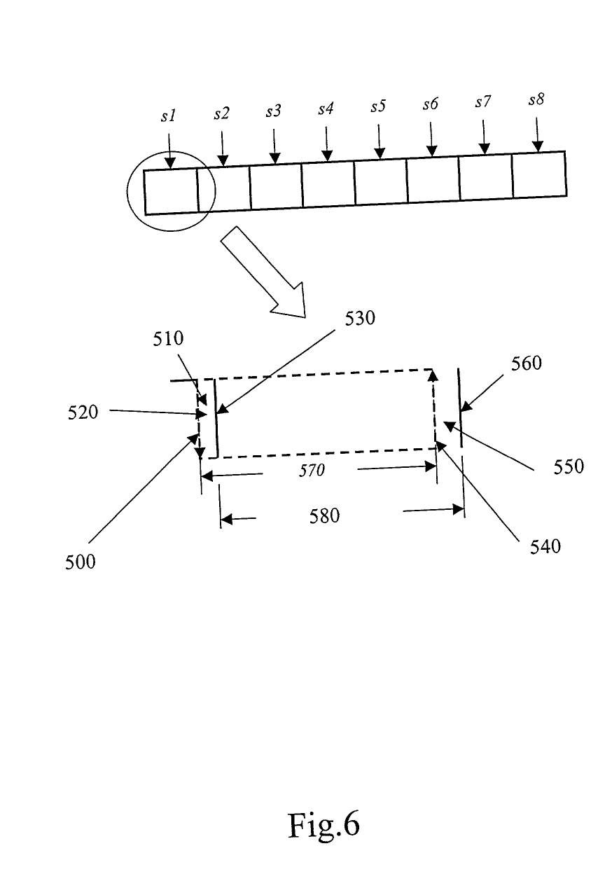

While in step 20 through step 40, as soon as the “target” device is initiated and start counting. The time latency in between the “initiating” and “start to counting” is a machine dependency issue. The longer the latency, the more time elapsed from incoming stream pulses. Refer to the FIG. 6, “Possible timing drift caused by device response performance”. When “target” device is interrupted, almost any device requires a certain amount of time for manipulating and then entering the counting routine. This time latency is named “latency1”. While in counting task, the “target” device also required to continuously monitoring whether this bit-frame has been elapsed. Notice that most devices are monitoring the bit-frame changes (exam the bit status) rather than use “interruption” function. Theoretically, monitoring a bit status is a slower performance compare with “interruption” function. This cause the second delay and here named “latency2”. Sum up all the latency and the bit-frame width, the actual measured bit-frame is possibly equal to measure bit_frame=−(f1(latency1)+(k(bit_frame))+(f2(latency2))). Where the f1 is the efficiency of manipulate the interruption, k is the counting resolution—there might have 1 count tolerance and f2 is the efficiency of monitoring the bit-frame change.

EA2. Counting resolution:

The counting task can almost synchronized to the interruption of incoming stream if the response performance of the “target” device is fast enough. However, at the end of bit-frame the device monitoring bit change performance is slower than the interrupt performance, therefore the “latency2” is theoretically longer than “latency1”. This cause the counting result inaccurate. It makes the measured bit-frame longer than the actual bit-frame length.

EA3. Floating point calculation errors:

Once the counting result is granted, the result is needed to be divided by the factor of two (2): (result/2), then stored at a proper location for later manipulation. If the “target” device does not support the floating-point calculation, then the remainder from the divide function will be truncated and this is the cause of calculation errors. The purpose of (result/2) is to locating the pointer to the center of a bit-frame when sampling data.

EA4. Timing drift margin:

Once the sampling constant (result) & (result/2) have been stored. When sampling bit2 through bit8, each time the pointer need to go through these steps locating_the_center_of_bit_frame, sampling_data, store_sampled then repeats until all bits has been sampled. All these steps requires certain amount of processor time. These processor time cause further latency or delay when sampling the following bits.

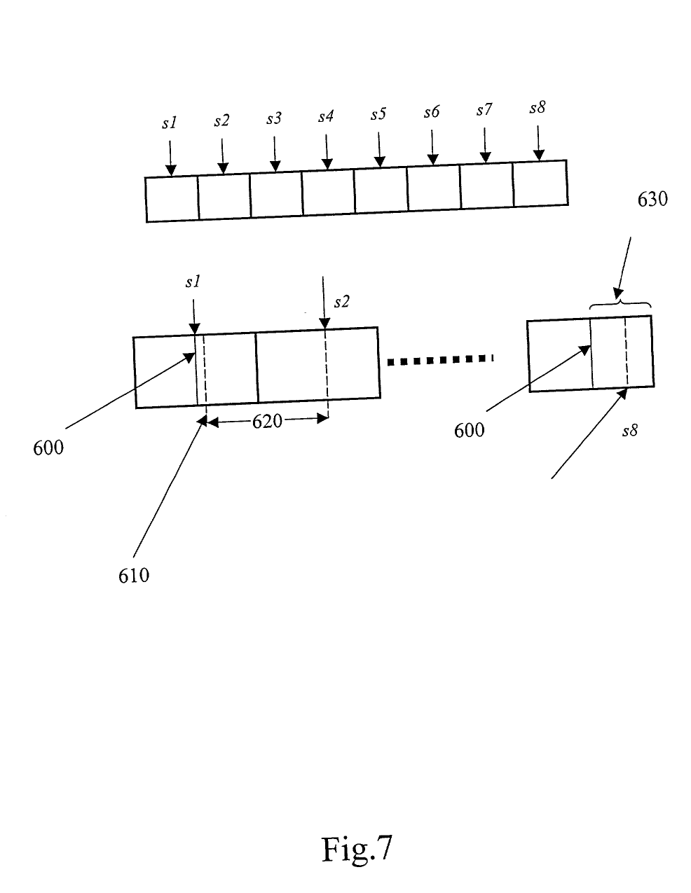

Refer to FIG. 7, “Possible sampling timing drift”:

In other words, after the 1st bit sampling, the sampling pointer located at the location slightly behind the center line of the 1st bit-frame, next, wait for a delay loop for locating the sampling pointer to the center line of the next bit-frame. Then repeat the same procedures for grab the next bit and similarly, further behind generated. This makes the sampling pointer more behind the center line of the next bit-frame. More bits sampled, more latency/delay accumulated.

Since the original concept of sampling bits is locating the pointer at the center of the bit-frame each time when intent to sampling data. The more manipulation, the more latency or delay generated and accumulated, therefore the maximum allowable accumulated timing drift margin is 50% of the total bit-frame.

To overcome these potential of timing drift out of margin, there are number of ways may be implemented.

Measure1. Use faster processor:

The faster processor generates less latency and therefore less delay over all 8 samples. The criteria of selecting processor can follow a simple rule: as long as the accumulated latency/delay is less than 50% of a bit-frame, it is qualified to be the right processor.

Measure2. Sampling ahead:

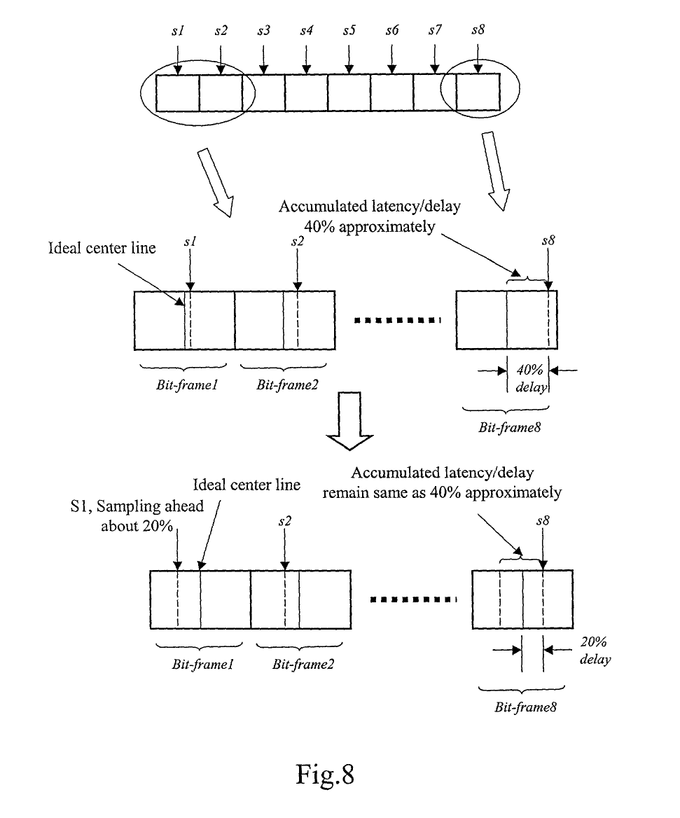

Since the latency/delay is always towards the end of bit stream. Sampling ahead of the center line of the bit-frame may gain extra allowable margin. Refer FIG. 8, “criteria of drifting margin & sampling ahead technique”. For example, if the 8th sampling locate at the 90% time from the starting of 8th bit-frame or 40% from the center line. Let the first sampling locate at 20% ahead of the center line, base on the same accumulated drift condition, the 8th sampling will take place at approximately 20% after the 8th center line. This is a more comfortable position compare with 40% delay. There are many alternatives to achieve the 20% ahead sampling, the following is one of the rules to criteria the sampling ahead=((result/2)-(result×20%)).

Mathematical verification:

As elaborate earlier, this present invention demonstrate an algorithm allows any non-precise time-based “target” device(s), any device(s) without internal UART or any unstable time-based device(s) to operate normally over the asynchronous communication applications.

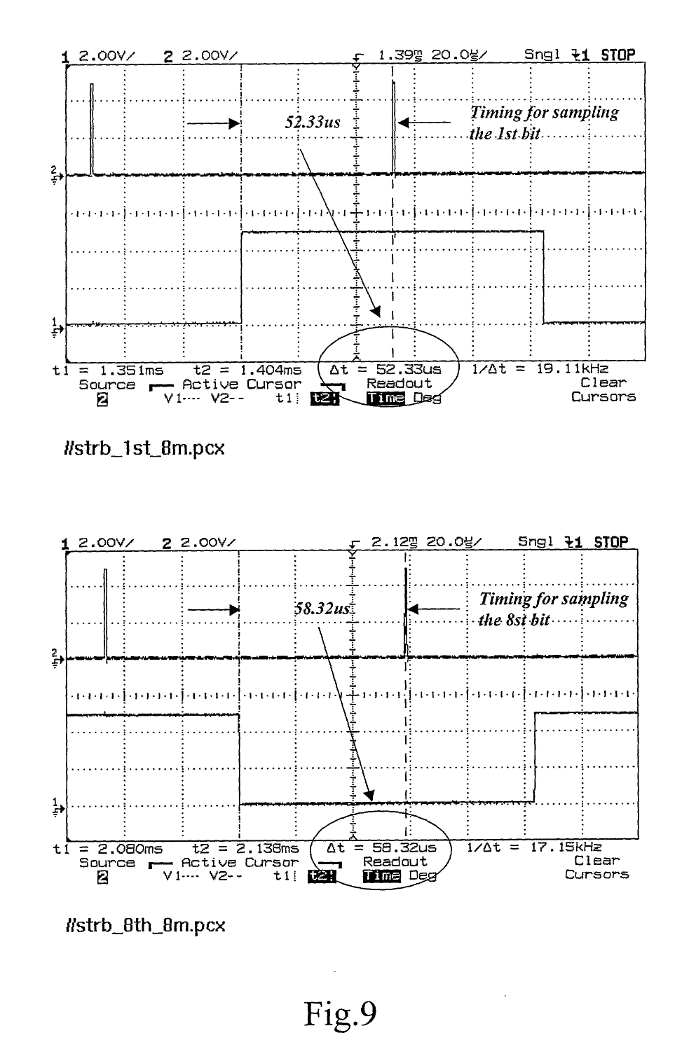

With the algorithm also mentioned earlier, the first received bit-frame was used for local timing calibration. Whatever the counting result is, it is always a mapping relationship to 104 us. This calibrated counting result with certain offset/compensation allows the “target” device to synchronically sampling the rest incoming bit stream. Shall any accumulated latency/delay caused by sampling all 8 bits, will be cancelled at the next START pattern. This enable the asynchronous communication maintain error free over the entire task. Refer FIG. 9, “Accumulated latency/delay, measured at 8 MHz”, at the top of FIG. 9, the 1st sampling strobe take place at 52.33 us from the beginning of that bit-frame. The accumulated error gradually add-up while grabbing the rest bits, while at the last bit—the 8th bit-frame, the accumulated latency/delay increase to 58.32 us. This was measured from a 8 MHz running processor. A faster running processor accumulated less latency/delay and a slower processor accumulated greater latency/delay. This accumulated latency/delay can be cancelled at the next START pattern. This will elaborated at a later section.

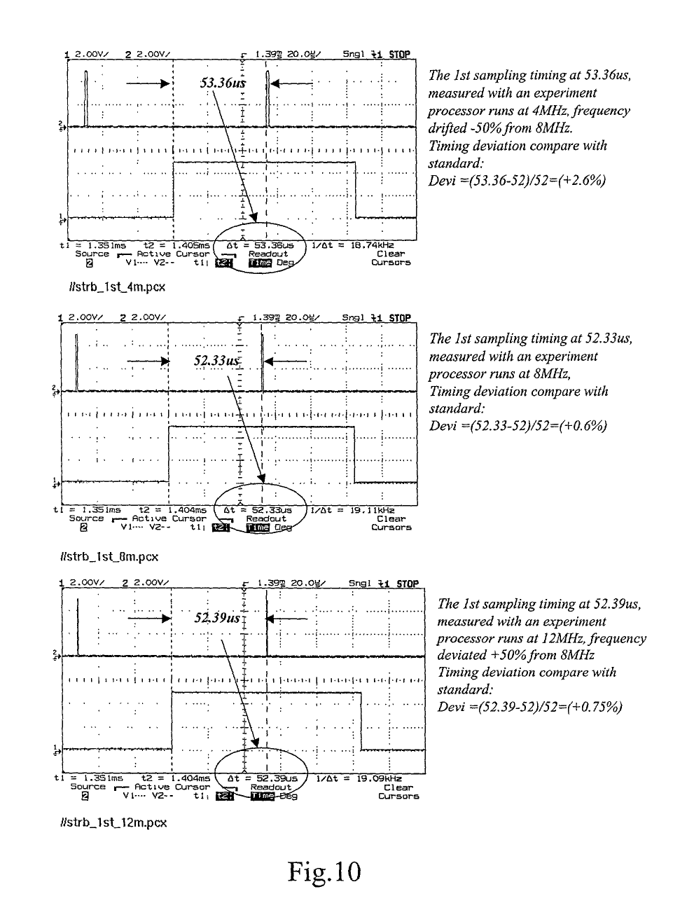

Refer to FIG. 10, “Calibrated sampling timing at the 1st bit-frame”. This present invention demonstrate an algorithm allows frequency tolerated for many different types of processors. Specially for those low cost entry level processors. After the the sampling timing is calibrated and the machine dependent compensation has done, the actual data sampling can be made relatively accurate.

At the top of FIG. 10, this was measured with a processor runs at 4 MHz which is −50% frequency drifted from 8 MHz, and the at the lower of FIG. 10 is a processor runs at 12 MHz which is drifted +50% from 8 MHz. All these three (3) processors samples the 1st bit at a relatively identical timing position. The maximum deviation compare with a standard 9600 baud is less than 2.6%.

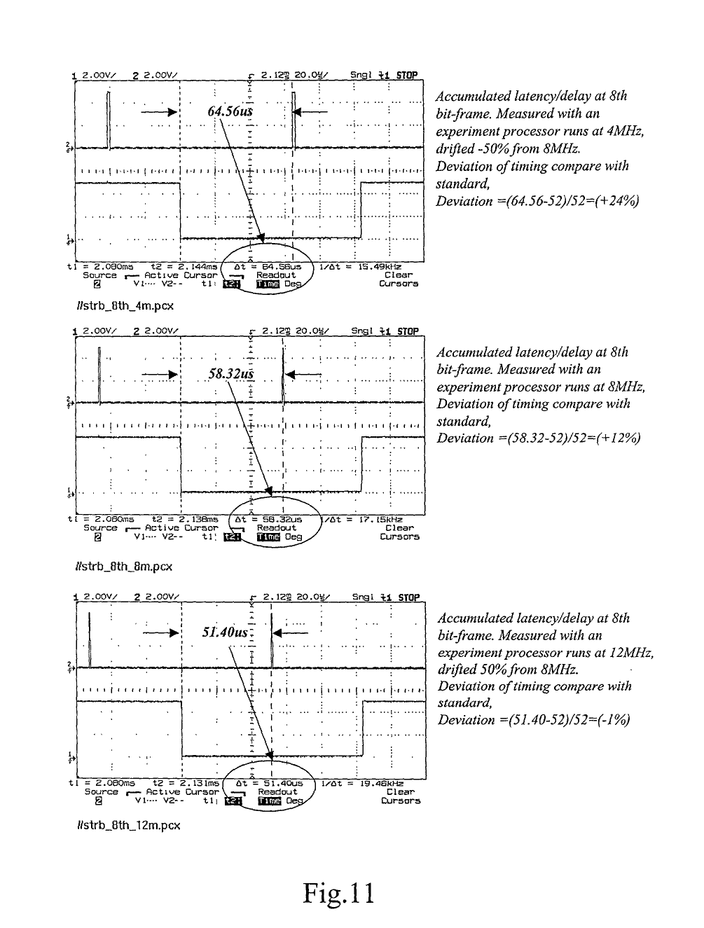

While the sampling go on, until the last bit—the 8th bit, the accumulated latency/delay are still within the tolerance. Refer to FIG. 11, “Accumulated latency/delay at 8th bit-frame”. The maximum accumulated latency/delay was made by the slowest processor which is the 4 MHz in this case. Although the accumulated latency/delay made by the 4 MHz processor was measured as +24% deviated from the standard 9600 baud, however, that is still within the margin. Notice that the fastest processor runs at 12 MHz results the accumulated latency/delay was measured as 51.40 us. This is even ahead of 52 us—the center line of 9600 baud bit-frame. This could be caused by the effect of offset/compensation process as mentioned earlier.

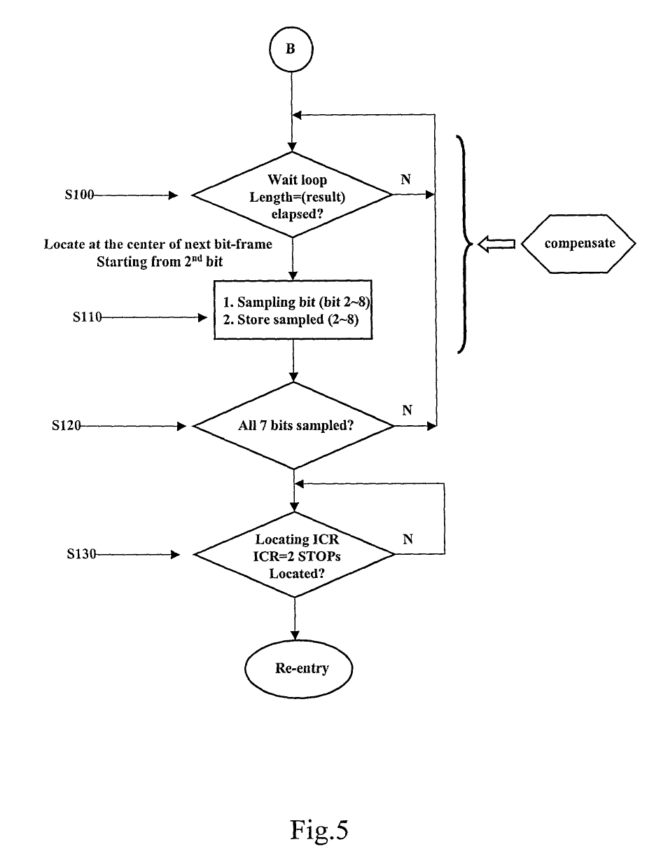

If all these accumulated latency/delay remains unchanged may cause later data retrieve error. However, this present invention enables the accumulated latency/delay to be cancelled at the next START bit received. Refer to FIG. 5, “Algorithm Flow-2”. After all 8 bits have been received, the processor pointer returns to step 90—the re-entry state, once in this state, the next incoming START bit interrupts the “target” device and then entering the same process routines as the cold-start does. Therefore all accumulated latency/delay will be cancelled and hence the asynchronous communication task goes on with no errors.

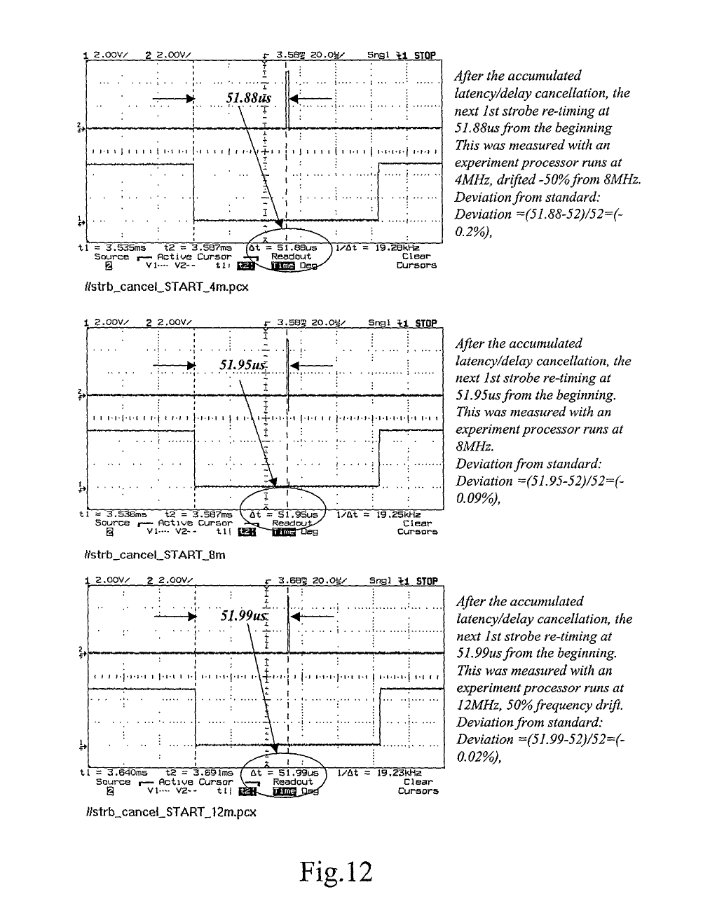

Refer to FIG. 12, “Accumulated latency/delay cancellation”. Once the accumulated latency/delay were cancelled, the next sampling timing shows that the new sampling strobe all re-positioned at a near perfect position. From the top to the bottom of FIG. 12, it shown the sampling timing positions for 4 MHz, 8 MHz and 12 MHz processors respectively. All the deviation from previous 24% resets to nearly zero (0) percent.

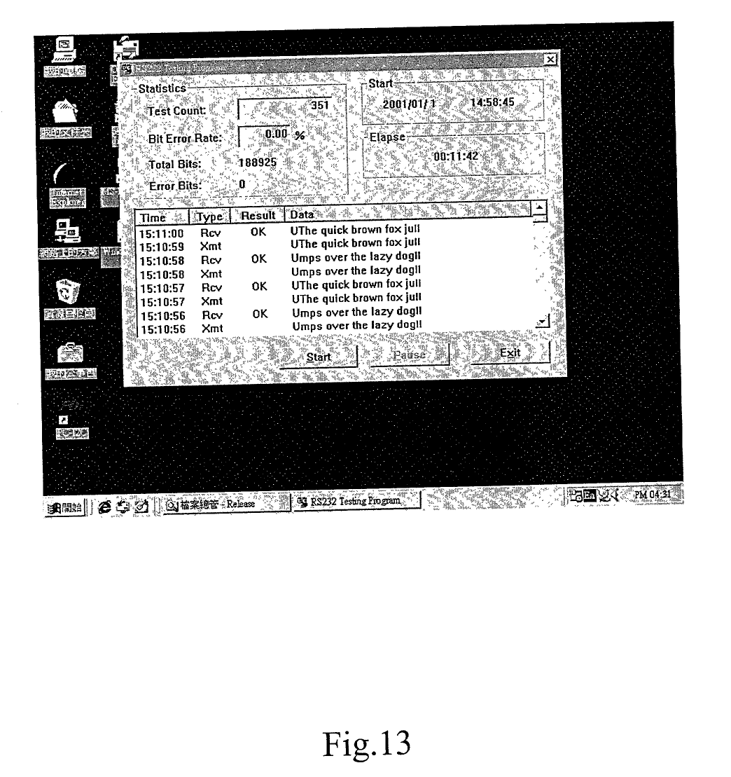

At the final, to prove the algorithm, a test program has been made for verifying the result of using a non-precise time-base “target” device. This device under test survives the asynchronous communication test. Refer to FIG. 13, “A BERT program”. This program allows the “initiator” sending out a pre-defined data stream, once the “target” device is interrupted and time-base calibrated, then each stream of data received by the “target” device will be echo back to the “initiator” device for verification.

The test pattern is “The quick brown fox jumps over the lazy dog”. Due to the limited “target” device buffer size, the test pattern break into two (2) streams. At the beginning of each stream, an U has been appended for time-base calibration purpose.

The test result shows the algorithm successful: no errors detected over 188925 bits being transmitted and echoed.

The advantages of using this invented approach are:

1. Eliminate the sophisticated time-base and/or frequency locking mechanism and therefore reduce cost.

2. The self calibration require only a single bit time width and once it is calibrated, any accumulated margin error can be cancelled at the beginning of the next incoming character. In other word, accumulated error cancelled by next incoming character START bit.

3. It is flexible to use whatever baud rate. The baud rate limitation is device dependent issue. Faster baud rate requires faster device.

Certain variations would be apparent to those skilled in the art, which variations are considered within the spirit and scope of the claimed invention.

What is claimed is:

1. A method for automatically calibration & synchronization for digital asynchronous communication, the inverter comprising:
(a)initialing a target device;
(b) beginning to counting as soon as the target device is detected by a falling edge of a incoming START bit;
(c)ending up the counting until a rising edge of the START bit detected;
(d) storing a counting result;
(e)setting the result/2 to be a sampling pointer;
(f) compensating a latency and elapsing a first wait loop;
(g) sampling and storing a first bit;
(h) compensating a latency and elapsing a second wait loop;
(i) sampling and storing in accordance with bits;
(j) identifying to sampling and storing 8 bits;
(k) locating a Inter Character Region according to the initialing; repeating to step(b)˜step(k).

2. The method for automatically calibration & synchronization for digital asynchronous communication of claim 1, wherein the digital asynchronous communication being applied to point to point system.

3. The method for automatically calibration & synchronization for digital asynchronous communication of claim 1, further comprising a stable time-base initiator device.

4. The method for automatically calibration & synchronization for digital asynchronous communication of claim 1, wherein the START bit selected from the group consisting of any standard communication protocol of the digital asynchronous communication.

5. The method for automatically calibration & synchronization for digital asynchronous communication of claim 4, wherein the standard communication protocol being IEEE-232.

6. The method for automatically calibration & synchronization for digital asynchronous communication of claim 1, wherein the Inter Character Region is is a guard band in between characters.

7. The method for automatically calibration & synchronization for digital asynchronous communication of claim 1, wherein the first wait loop is equal to the result/2.

8. The method for automatically calibration & synchronization for digital asynchronous communication of claim 1, wherein the second wait loop is equal to the result.
